(19) United States
(12) Patent Application Publication
(10) Pub. No.: US 2014/0282248 A1
(43) Pub. Date: Sep. 18, 2014

(54) ENHANCED VIEWS WITH DYNAMIC MENUS

(71) Applicant: Microsoft Corporation, Redmond, WA (US)

(72) Inventors: Brendan J. Reeves, Seattle, WA (US); Jason A. Cook, Renton, WA (US); Kenneth Fern, Bellevue, WA (US); Michael Anthony Faoro, North Bend, WA (US); Joseph P. McLaughlin, Seattle, WA (US); Jonathan David Friedman, Seattle, WA (US); Jasdeep Singh Chugh, Newcastle, WA (US)

(21) Appl. No.: 13/915,806

(22) Filed: Jun. 12, 2013

Related U.S. Application Data
(60) Provisional application No. 61/777,088, filed on Mar. 12, 2013.

(51) Int. Cl. G06F 3/0482

(52) U.S. Cl. CPC G06F 3/0482
USPC 715/825

(57) ABSTRACT

Disclosed herein are systems, methods, and software for facilitating enhanced views of information management applications. In an implementation, a suitable computing system or systems presents a link to a dynamic menu within a perspective of an active module of various modules in an information management application. In response to an indication of interest generated with respect to the link, the computing system presents the dynamic menu which includes various dynamic icons. Each of the icons provides update information and a link associated with a corresponding module of the various modules in the information management application.

### RELATED APPLICATIONS

This application claims the benefit of and priority to U.S. Patent Application No. 61/777,088, filed on Mar. 12, 2013, and entitled ENHANCED VIEWS WITH DYNAMIC MENUS, which is hereby incorporated by reference in its entirety.

### TECHNICAL FIELD

Aspects of the disclosure are related to computing hardware and software technology, and in particular to information management applications.

### TECHNICAL BACKGROUND

Information management applications provide users with effective and convenient ways to communicate with others and manage their information. Examples of information management applications include but are not limited to email applications and calendar applications. Some information management applications integrate these various types of applications by way of modules, such as email, calendar, contact, and task modules, although each type of application or functionality may also be provided in a stand-alone manner. Microsoft® Outlook® is one example of an information management application.

While many information management applications are provided as locally installed and executed applications, many can be experienced in a wide variety of ways. For example, some information management applications are available as web-based applications that are experienced through a browser application, as mobile applications customized for mobile environments, or even as a mobile web-based application generally developed for a mobile browser experience. In addition, information management applications can be experienced on a wide variety of computing devices, such as desktop, laptop, or tablet computers, mobile phones, gaming systems, Internet appliances, or any other physical or virtual computing system, variation, or combination thereof.

In many information management applications, any given module may include various panels and other components. In an example, an email module may include various features and functions arranged within a view of the email module. An inbox panel may include various emails in an inbox, while a preview panel may provide a preview of content in an email. The email module may also include a navigation panel, within which may be presented various navigation tools that enable a user to navigate the application.

One particular navigation tool includes several icons representative of the various modules in an application, the selection of which navigates a user to a view of an associated module. For example, a group of icons may be presented in a navigation panel, including an email icon, calendar icon, contacts icon, and task icon. A selection of any one of the icons navigates the user to the module associated with that icon.

### Overview

Provided herein are systems, methods, and software for facilitating enhanced views of information management applications. In an implementation, a suitable computing system or systems presents a link to a dynamic menu within a perspective of an active module of various modules in an information management application. In response to an indication of interest generated with respect to the link, the computing system presents the dynamic menu which includes various dynamic icons. Each of the icons links to and provides update information associated with a corresponding module of the various modules in the information management application.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a view of an information management application and an operational scenario in an implementation.

FIG. 2 illustrates an enhanced view process in an implementation.

FIG. 3 illustrates a computing architecture in an implementation.

FIG. 4 illustrates a communication environment in an implementation.

FIG. 5 illustrates various scenarios involving a view of an information management application in various implementations.

FIG. 6 illustrates various scenarios involving a view of an information management application in various implementations.

FIG. 7 illustrates a view of an information management application and an operational scenario in an implementation.

FIG. 8 illustrates a view of an information management application and an operational scenario in an implementation.

FIG. 9 illustrates a view of an information management application and an operational scenario in an implementation.

FIG. 10 illustrates an enhanced software model in an implementation.

### TECHNICAL DISCLOSURE

Implementations disclosed herein facilitate improved information management applications. In at least one implementation, an enhanced view of an information management application includes a link to a dynamic menu within a perspective of an active module of the various modules supported in the application. For example, an information management application may include an email module, a contact module, a calendar module, or the like. A link to the dynamic menu may be included within any one or all of the modules that is associated with a dynamic menu.

While interacting with a suitable computing system implementing all or a portion of the information management application, a user may click on, touch, select, or otherwise make an indication of interest with respect to the link. In response to the indication of interest, the computing system presents the dynamic menu. The dynamic menu may include various icons, each corresponding to a different one of the modules in the application. For example, the icons may include an email icon, a contacts icon, a calendar icon, and so on. The icons may be dynamic in that update information pertaining to their associated modules may be presented within the icon. An indication of interest made with respect to any of the icons may navigate a user to its associated module.

In this manner, a user may navigate between modules by selecting the link and then selecting any one of the icons presented within the dynamic menu. In addition, the user may be presented with update information while viewing the menu, which may contribute to their decision on which module to navigate to next.

In some implementations, the link is a menu graphic or graphical icon. The menu graphic may persist in each perspective associated with the various modules in the information management application. For example, the menu graphic may be displayed in approximately the same place in each perspective. This may enable a user to become familiar with its location so that, no matter which perspective the user is viewing, the user can navigate to the dynamic menu with ease.

The dynamic icons presented in the dynamic menu may be, for example, live tiles, each of which may be updated with the update information. The tiles are dynamically connected to the information management application such that they may receive and present the update information from within the tile. It may be appreciated that the tiles are arranged and presented from within the information management application.

In some implementations, presenting the dynamic menu involves replacing the perspective of the active module with the dynamic menu. For example, a perspective on an active module may occupy most, if not all, of the display space available on a display. Examples of perspectives include screen views, web pages, mobile web pages, and the like. Upon selecting the menu graphic from the perspective on the active module, the perspective may be entirely replaced by the dynamic menu.

Examples of the various modules in the information management application include an email module, a contacts module, and a calendar module. It may be appreciated that other modules in addition to or in place of the aforementioned modules are possible. The dynamic icons may be, for example, an email icon linked to the email module, a contacts icon linked to the contacts module, and a calendar icon linked to the calendar module.

Other types of applications other than information management applications may also be considered within the scope of the present disclosure. Any kind of application may include modules and a dynamic menu such as those disclosed herein, including productivity applications, database applications, and gaming applications.

In some scenarios a dynamic menu includes at least one dynamic icon linked to an application other than the application within which the dynamic menu is presented. In an example involving an information management application, the dynamic menu may include a dynamic icon linked to an application separate from the information management application, such as a weather application, a social networking application or any other application. In another example, an application may include a dynamic menu with a dynamic icon that links to an information management application.

Referring now to the drawings, FIG. 1 illustrates an enhanced calendar view of an information management application and an operational scenario associated with an enhanced view process illustrated in FIG. 2. FIG. 3 illustrates a computing architecture suitable for any computing system or systems that may employ the enhanced view process of FIG. 2. FIG. 4 illustrates a communication environment in which an information management application and associated services may be deployed. FIGS. 5-9 illustrate various views and associated operational scenarios related to various features and functionality that may be provided by an information management application. FIG. 10 illustrates an enhanced software model in an implementation.

Turning to FIG. 1, an enhanced view 100 of an information management application is illustrated in an implementation. FIG. 1 also illustrates an operational scenario that may occur when the information management application implements or is otherwise subject to enhanced view process 200 illustrated in FIG. 2. The following discussion of FIG. 1 therefore makes parenthetical reference to the various steps included in enhanced view process 200.

Initially, enhanced view 100 is presented, including a calendar perspective having various calendar units (step 201). Enhanced view 100 includes information bar 101, calendar module 103, and calendar perspective 105. In this implementation, the calendar perspective 105 is a daily perspective and includes a scheduled event 107. Enhanced view 100 also includes a menu graphic 109, the selection of which navigates a user to a dynamic menu 111 for its presentation (step 203).

The information management application, of which enhanced view 100 provides one representation, may be any application or collection of applications, module or collection of modules, service or services, or any variation or combination thereof capable of providing information management services and functionality. Examples of the information management application include Microsoft® Outlook®, Outlook® Web App, Mobile Outlook®, Hotmail®, Outlook.com, and Gmail, as well as any other information management application.

The information management application may include one or more information modules, of which calendar module 103 is representative. Calendar module 103 may be any component or other aspect of the information management application with which a user interacts to gain access to at least some of the various calendaring functions and services provided by the information management application, such as the ability to schedule events, invites others to participate in events, and the like. Other example modules include email modules, task modules, and contact modules, as well as any other type of module, combination, or variation thereof.

Dynamic menu 111 includes various module icons associated with each module included in the information management application. In this example, dynamic menu 111 includes but is not limited to email icon 113, contacts icon 115, and calendar icon 117. It may be appreciated that each icon is dynamic and can include update information associated with its corresponding module. For example, email icon 113 includes a new email alert and calendar icon 117 includes an appointment reminder. Dynamic menu 111 also includes menu graphic 109, although this may be optional.

In operation, monitoring is performed for an indication of interest 119 made with respect to any of the module icons. The indication of interest may be, for example, a touch, a click, or some other selection or indication. In this example, indication of interest 119 is made with respect to email icon 113, leading to the presentation of email module 121 (step 205). Email module 121 includes various emails 123, 125, 127, and 129. It may be appreciated that email module 121 may include other elements, features, and aspects.

It may also be appreciated that, while the discussion of enhanced view process 200 illustrated in FIG. 2 generally refers to specific steps, such as presenting a perspective or presenting a dynamic menu, variations of the process are possible and may be considered within the scope of the present disclosure. Taking the step of initiating any of the aforementioned steps, as opposed to fully carrying them out, may be considered a variation. Thus, initiating presentation of any of the various perspectives may be considered a variation on the specific steps illustrated in FIG. 2.

The term presenting as used herein generally refers to the various capabilities employed in various computing architectures to assemble information that can then be used by other capabilities to generate an image or images. Within the context of enhanced view process 200, for example, presenting an enhanced view or making any modifications thereof may generally refer to assembling the information or data used to generate an image or images that together result in those features.

However, it may be appreciated that other perspectives on presenting may be considered within the scope of the present disclosure. For example, presenting as used herein may also, in some scenarios, be considered to refer to the various capabilities employed by various computing architectures to generate an image or images from information assembled for that purpose. With respect to enhanced view process 200, presenting an enhanced view or making a modification to it, or an effect with respect to it, may refer to generating an image or images, from information assembled for that purpose, that together result in those features.

It may also be appreciated that presenting in some scenarios may refer to a combination of the aforementioned possibilities. For example, presenting in some scenarios may refer to both assembling the information used to generate an image or images for a feature and then generating the image or images for the feature. In addition, a wide variety of other steps, processes, and stages may occur within the context of presenting features of an application, such as driving the display of, or even actually displaying, images or other representations of a feature, all of which may be considered part of presenting a feature.

Referring now to FIG. 3, computing architecture 300 is representative of an architecture that may be employed in any apparatus, system, or device, or collections thereof, to suitably implement all or portions of enhanced view process 200 illustrated in FIG. 2, or variations thereof, and optionally all or portions of the information management application referred to with respect to FIG. 1. Enhanced view process 200 may be implemented on a single apparatus, system, or device or may be implemented in a distributed manner. The information management application may also be implemented on a single apparatus, system, or device or may be implemented in a distributed manner. Enhanced view process 200 may be integrated with the information management application, but may also stand alone or be embodied in some other application.

Computing architecture 300 may be employed in, for example, desktop computers, laptop computers, tablet computers, notebook computers, mobile computing devices, cell phones, media devices, and gaming devices, as well as any other type of physical or virtual computing machine and any combination or variation thereof. Computing architecture 300 may also be employed in, for example, server computers, cloud computing platforms, data centers, any physical or virtual computing machine, and any variation or combination thereof.

Computing architecture 300 includes processing system 301, storage system 303, software 305, communication interface system 307, and user interface system 309. Processing system 301 is operatively coupled with storage system 303, communication interface system 307, and user interface system 309. Processing system 301 loads and executes software 305 from storage system 303. When executed by processing system 301, software 305 directs processing system 301 to operate as described herein for enhanced view process 200 or its variations. Computing architecture 300 may optionally include additional devices, features, or functionality not discussed here for purposes of brevity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations, or variation.

Storage system 303 may comprise any computer readable storage media readable by processing system 301 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal.

In addition to storage media, in some implementations storage system 303 may also include communication media over which software 305 may be communicated internally or externally. Storage system 303 may be implemented as a single storage device but may also be implemented across multiple storage devices or sub-systems co-located or distributed relative to each other. Storage system 303 may comprise additional elements, such as a controller, capable of communicating with processing system 301 or possibly other systems.

Software 305 may be implemented in program instructions and among other functions may, when executed by processing system 301, direct processing system 301 to operate as described herein for enhanced view process 200 illustrated in FIG. 2. In particular, the program instructions may include various components or modules that cooperate or otherwise interact to carry out enhanced view process 200. The various components or modules may be embodied in compiled or interpreted instructions or in some other variation or combination of instructions. The various components or modules may be executed in a synchronous or asynchronous manner, in a serial manner or in parallel, in a single threaded environment or multi-threaded, or in accordance with any other suitable execution paradigm, variation, or combination thereof. Software 305 may include additional processes, programs, or components, such as operating system software or other application software. Software 305 may also comprise firmware or some other form of machine-readable processing instructions executable by processing system 301.

In general, software 305 may, when loaded into processing system 301 and executed, transform a suitable apparatus, system, or device employing computing architecture 300 overall from a general-purpose computing system into a special-purpose computing system customized to facilitate enhanced calendar views as described herein for each implementation. Indeed, encoding software 305 on storage system 303 may transform the physical structure of storage system 303. The specific transformation of the physical structure may depend on various factors in different implementations of this description. Examples of such factors may include, but are not limited to, the technology used to implement the storage media of storage system 303 and whether the computer-storage media are characterized as primary or secondary storage, as well as other factors.

For example, if the computer-storage media are implemented as semiconductor-based memory, software 305 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing architecture 300 is generally intended to represent an architecture on which software 305 may be deployed and executed in order to implement enhanced view process 200 (or variations thereof) and optionally all or portions of an information management application. However, computing architecture 300 may also be suitable for any computing system on which software 305 may be staged and from where software 305 may be distributed, transported, downloaded, or otherwise provided to yet another computing system for deployment and execution, or yet additional distribution.

Referring again to FIG. 1, through the operation of a suitable computing system employing software 305, transformations may be performed with respect to enhanced view 100. As an example, enhanced view 100 could be considered transformed from one state to another when subject to enhanced view process 200. In a first state, the computing system presents enhanced view 100, including a perspective on an active module. Responsive to a selection of a menu graphic, enhanced view 100 may change to include a presentation of a dynamic menu, thereby changing enhanced view 100 to a different state.

Referring again to FIG. 3, communication interface system 307 may include communication connections and devices that allow for communication with other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface system 309 may include a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 309. In some cases, the input and output devices may be combined in a single device, such as a display capable of displaying images and receiving touch gestures. The aforementioned user input and output devices are well known in the art and need not be discussed at length here. User interface system 309 may also include associated user interface software executable by processing system 301 in support of the various user input and output devices discussed above. Separately or in conjunction with each other and other hardware and software elements, the user interface software and devices may support a graphical user interface, a natural user interface, or the like.

FIG. 4 illustrates a communication environment 400 in which various information management applications may be supported to implement enhanced calendar views and their associated operations, such as enhanced view 100 discussed with respect to FIG. 1. Communication environment 400 includes application platform 401, application platform 403, and application platform 405. Application platform 401 and application platform 403 may communicate with service environment 407 to access information exchange service 417 on behalf of information management application 411 and information management application 413 respectively. Application platform 405 may communicate with service environment 409 to access information exchange service 419 on behalf of information management application 415. From time to time, service environment 407 and service environment 409 may communicate in furtherance of interaction between information exchange service 417 and information exchange service 419

Examples of application platforms 401, 403, and 405, include, but are not limited to, desktop computers, work stations, laptop computers, notebook computers, tablet computers, mobile phones, personal digital assistances, media devices, gaming devices, and any other physical or virtual computing machine or combinations and variations thereof capable of implementing at least one of a variety of information management applications. Service environment 407 may be any computing system or collection of computing systems capable of implementing an information exchange service 417.

Application platforms 401, 403, and 405 may each be any computing apparatus, system, device, or collections thereof that employ a computing architecture suitable for implementing information management application 411, 413, or 415 respectively. Computing architecture 300 referred to with respect to FIG. 3 is one such representative architecture. Information management applications 411, 413, and 415 may each be any version or variety of an information management application. Examples include but are not limited to locally installed and executed applications, streaming applications, web-based applications that execute at least in part within the context of a browser application, mobile applications, mobile web-based applications that execute at least in part within the context of a mobile browser application, or any other application type, variation, or combination thereof.

Information management applications 411, 413, and 415 may each be embodied in program instructions that, when executed by application platforms 401, 403, and 415 respectively, direct each to operate as described herein for enhanced view process 200 discussed with respect to FIG. 2. The program instructions may take the form of compiled object code, interpreted scripts, or any other suitable form of program instructions that may be executed directly or indirectly by an application platform, as well as any suitable variation or combination thereof. Examples of information management applications include but are not limited to Microsoft® Outlook®, Mozilla Thunderbird/Lightening, Open Xchange, Microsoft® Outlook® Web App, Microsoft® Outlook® Web App for mobile devices, Outlook.com®, Gmail, and Microsoft® Outlook® for mobile devices, as well as another suitable information management application, variation, or combination thereof.

Service environment 407 and service environment 409 may each include any computing apparatus, system, device, or collections thereof that employ a computing architecture suitable for implementing information exchange service 417 and information exchange service 419 respectively. Computing architecture 300 referred to with respect to FIG. 3 is one such representative architecture. Examples include server computers, cloud computing platforms, data centers, and any physical or virtual computing machine, as well as any variation or combination thereof. Examples of information exchange service 417 and information exchange service 419 include but are not limited to Microsoft® Exchange®, Microsoft® O365®, Hotmail®, Outlook.com®, and Gmail, as well as any other information exchange service, combination, or variation thereof capable of operating as described herein.

In operation, any of applications platforms 401, 403, and 405 may communicate from time to time with service environment 407 or service environment 409 over communication network 410 to facilitate the exchange of information between information management applications 411 and 413 and information exchange service 417 and between information management application 415 and information exchange service 419. Service environment 407 and service environment 409 may also communicate over communication network 410 to facilitate the exchange of information.

Communication between any of the elements contemplated in FIG. 4 may occur in accordance with various communication protocols, such as the Internet protocol (IP, IPv4, IPv6, etc.), the transfer control protocol (TCP), and the user datagram protocol (UDP), as well as any other suitable communication protocol, variation, or combination thereof. Communication network 410 may be representative of a network or collection of networks over which the elements contemplated in FIG. 4 may exchange information, such as an intranet, the Internet, a local area network, a wide area network, a wireless network, a wired network, or any combination or variation thereof. Communication network 410 may include connections, devices, and communication media, such as metal, glass, air, or any other suitable communication media over which information may be exchanged. The aforementioned communication media, network, connections, protocols, and devices are well known and need not be discussed at length here.

The manner in which information is exchanged may vary. In some implementations, an application may exchange information with a service environment and information exchange service in accordance with various information exchange protocols, such as IMAP (internet message access protocol), POP (post office protocol), SMTP (simple mail transfer protocol), and MAPI (message application programming interface). In other implementations, an application may exchange information with a service environment and information exchange service in accordance with various other information exchange protocols, such as HTTP (hypertext transfer protocol), REST (representational state transfer), or WebSocket, as well as any other suitable information exchange protocol, variation, or combination thereof.

What information is exchanged or what format the information takes may also vary. For example, an application or associated browser (in the case of a browser based application) may receive information formatted in accordance with a variety of information protocols, such as DOM (Document Object Model), HTML (hypertext markup language), CSS (cascading style sheets), HTML5, XML (extensible markup language), Javascript, JSON (Javascript Object Notation), and AJAX (Asynchronous Javascript and XML), as well as any suitable information protocol, variation, or combination thereof. The information may include data or objects that may be processed for presentation, such as images and text. However, the information may also include scripts or other information that may be interpreted or otherwise processed by the browser or some other application for execution. In other implementations, an application may exchange discrete messages representative of an email, calendar event, or some other item of information formatted in accordance with an information protocol suitable to that application.

FIG. 5 illustrates one exemplary view 501 that may be rendered by one or more of information management applications 411, 413, and 415. In addition, three different scenarios 591, 593, and 595 are illustrated to demonstrate how view 501 may be scaled based on the form factor of a rendering device. In scenario 591, view 501 is rendered in full and may be representative of a view displayed on a relatively large screen, such as a computer monitor or other suitable device. In scenario 593, view 501 is scaled down relative to its presentation in scenario 591, and may be representative of an application scale experienced on a tablet device or some other device having smaller dimensions. In scenario 595, view 501 is scaled down even more relative to scenario 591 and scenario 593 and may be representative of an application scale experience on a mobile phone or other similar devices.

In scenario 591, view 501 includes an information area 511 that may be used to display the name of the application or other suitable information. Information area 511 includes several selectable options that, when selected, launch the presentation of other views associated with other modules. In particular, mail option 512 corresponds to an email module, calendar option 513 corresponds to a calendar module, contacts option 514 corresponds to a contacts module, and tasks option 515 corresponds to a tasks module. Information area 511 also includes an identity option 516 representative of an identity of a user engaged with view 501. View 501 also includes menu graphic 597, the selection of which can navigate a user to a display menu, such as dynamic menu 111 discussed with respect to FIG. 1. View 501 may include additional features or some of the features discussed herein may be omitted.

For exemplary purposes, it is assumed that mail option 512 has been selected and thus view 501 is representative of a view that may be encountered when working with an email module. Accordingly, view 501 includes various panels having various items and other functionality rendered and available for interaction with a user. Navigation panel 521 includes, but is not limited to, various folders that a user may select in order to access their contents, such as an inbox folder 525, a sent folder 527, and a drafts folder 529. Depending upon which folder is selected, its corresponding contents may be displayed in the panel adjacent to navigation panel 521. It is assumed here for exemplary purposes that inbox folder 525 is selected. Accordingly, inbox 531 and its contents are displayed adjacent to navigation panel 521, including emails 532, 533, 534, 535, 536, and 537. It may be appreciated that the various panels and their contents could be arranged in a variety of ways and are not limited to just those disclosed herein.

Content panel 539 provides a more detailed view of a selected item. For example, content panel includes content associated with email 536, assumed for exemplary purposes to have been selected by a user for reading, editing, or the like. Other aspects may be included in content panel 539, such as in-line reply capabilities, that are well known and need not be discussed at length here.

In scenario 593, information area 511 is considerably smaller relative to its size in scenario 591. In addition, navigation panel 521 is absent. It may be appreciated that other configurations are possible that would results in a smaller scale for view 501 and may be considered within the scope of the present disclosure. For example, other elements may be absent rather than, or in addition to, navigation panel 521.

In scenario 595, content panel 539 is absent, in addition to navigation panel 521, and thus the scale of view 501 is considerably smaller than in scenario 591 or 593. It may be appreciated that other configurations are possible that would results in a smaller scale and may be considered within the scope of the present disclosure, such as by eliminating other elements in place of or in addition to navigation panel 521 and content panel 539.

FIG. 6 illustrates various scenarios 693, and 695 that again demonstrate how an information management application may scale to fit the display dimensions of a given device. Scenarios 693, and 695 illustrate the same view 501 as in FIG. 5, except that it is assumed here for exemplary purposes that calendar option 513 has been selected. In scenario 693, view 501 may be representative of a view displayed on a variety of screens, such as a computer monitor, tablet device, or the like. In scenario 695, view 501 is scaled down relative to scenario 693 and may be representative of an application scale experience on a mobile phone or other similar devices.

When selected and active, the calendar module in scenario 691 includes but is not limited to a calendar panel 545. Calendar panel 545 includes a calendar perspective 547 on a month to which a user navigated. Calendar perspective 547 includes a grid and various days within the grid. It is assumed here for exemplary purposes that a secondary indication of interest 549 has been made and a secondary event perspective 551 presented in response thereto. The secondary event perspective 551 includes a subset of controls 553, 555, and 557 that might be available via a primary event perspective.

Scenario 695 illustrates a scaled down version of view 501. In this scenario, calendar perspective 547 is slightly compressed relative to its previous presentation. Secondary event perspective 551 appears largely the same, although it may be appreciated that changes may also be made with respect to it in order to conform to device dimensions.

FIG. 7 illustrates a scenario 793 in an implementation that demonstrates the inclusion of a dynamic menu in an information management application that includes a dynamic icon associated with another application. Enhanced view 700 includes dynamic menu 711 representative of a menu that may be presented in response to a selection of a menu graphic in some other view, page, or perspective. Dynamic menu 711 includes various live tiles, such as email tile 713, contacts tile 715, and calendar tile 717. It may be appreciated that email tile 713, contacts tile 715, and calendar tile 717 may correspond to various modules in the information management application. Email tile 713, contacts tile 715, and calendar tile 717 link to and present update information corresponding to the various modules in the information management application.

Dynamic menu 711 also includes a social network tile 716 representative of any tile that may be associated with any application other than the information management application. Examples of other applications that may be associated with live tiles in dynamic menu 711 include, but are not limited to, weather, productivity, database, music, video, conferencing, or gaming applications, as well as any other type of application. Social network tile 716 includes update information associated with the social networking application. Social network tile 716 may also include a link to the application.

In operation, a user may make an indication of interest 719 with respect to any of the dynamic tiles in dynamic menu 711, which in this case is social network tile 716. Examples of the indication of interest 719 include, but are not limited to, a mouse click, a touch, a hover, or some other user input or gesture.

In response to the indication of interest 719, view 702 of the social networking application is presented. View 702 includes various elements that may be found in a social networking application, such as an information bar 720, and various panels 721, 723, and 725. It may be appreciated that the elements of view 702 are provided merely for exemplary purposes and not for purposes of limiting the scope of the present disclosure.

FIG. 8 illustrates scenario 893 in another implementation that demonstrates a dynamic menu in an information management application and a representative interaction with a dynamic tile associated with a module in the information management application. Enhanced view 800 includes dynamic menu 811 representative of a menu that may be presented in response to a selection of a menu graphic in some other view, page, or perspective. Dynamic menu 811 includes various live tiles, such as email tile 813, contacts tile 815, and calendar tile 817. It may be appreciated that email tile 813, contacts tile 815, and calendar tile 817 may correspond to various modules in the information management application. Email tile 813, contacts tile 815, and calendar tile 817 link to and present updates corresponding to the various modules in the information management application.

Dynamic menu 811 also includes a weather tile 816 representative of any tile that may be associated with any application other than the information management application. Examples of other applications that may be associated with live tiles in dynamic menu 811 include, but are not limited to, social networking, productivity, database, music, video, conferencing, or gaming applications, as well as any other type of application. Weather tile 816 includes update information associated with the weather application, such as a limited forecast. Weather tile 816 may also include a link to the weather application.

In operation, a user may make an indication of interest 819 with respect to any of the dynamic tiles in dynamic menu 811, which in this case is calendar tile 817. Examples of the indication of interest 819 include, but are not limited to, a mouse click, a touch, a hover, or some other user input or gesture.

In response to the indication of interest 819, enhanced view 800 of the information management application is changed to present a peek 851 on at least one event in the calendar module with which calendar tile 817 is associated. The peek 851 is any graphical element that can include information associated with an underlying object or application, such as an event scheduled on a calendar provided by the calendar module. It may be appreciated that other types of interaction with the dynamic tiles in dynamic menu 811 may be possible, such as the ability to delete emails previewed through email tile 813 or launch communications with contacts represented in contacts tile 815.

FIG. 9 illustrates scenario 993 in another implementation that demonstrates a dynamic menu in an information management application and a representative interaction with a dynamic tile associated with another application. Enhanced view 900 includes dynamic menu 911 representative of a menu that may be presented in response to a selection of a menu graphic in some other view, page, or perspective. Dynamic menu 911 includes various live tiles, such as email tile 913, contacts tile 915, and calendar tile 917. It may be appreciated that email tile 913, contacts tile 915, and calendar tile 917 may correspond to various modules in the information management application. Email tile 913, contacts tile 915, and calendar tile 917 link to and present update information corresponding to the various modules in the information management application.

Dynamic menu 911 also includes a weather tile 916 representative of any tile that may be associated with any application other than the information management application. Examples of other applications that may be associated with live tiles in dynamic menu 811 include, but are not limited to, social networking, productivity, database, music, video, conferencing, or gaming applications, as well as any other type of application. Weather tile 916 includes update information associated with the weather application, such as a limited forecast. Weather tile 916 may also include a link to the weather application.

In operation, a user may make an indication of interest 919 with respect to any of the dynamic tiles in dynamic menu 911, which in this scenario is calendar tile 917. Examples of the indication of interest 919 include, but are not limited to, a mouse click, a touch, a hover, or some other user input or gesture.

In response to the indication of interest 919, enhanced view 900 of the information management application is changed to present a peek 951 on at least some of the weather information generated by the weather application, such as a forecast extended relative to the limited forecast presented by weather tile 916. The peek 951 is any graphical element that can include information associated with an underlying object or application, such as a weather forecast provided by a weather application. It may be appreciated that other types of interaction with the dynamic tiles in dynamic menu 911 may be possible, such as the ability to delete emails previewed through email tile 913, launch communications with contacts represented in contacts tile 915, or modify or respond to events in calendar tile 917.

FIG. 10 illustrates a software model 1000 representative of one way in which enhanced views with dynamic menus may implemented. Software model 1000 illustrates the various software layers at which dynamic tiles may be implemented.

In particular, dynamic application tiles 1003 may be presented at the operating system layer 1001. One such example are the dynamic tiles presented in the user interface to Microsoft Windows 8®. However, dynamic application tiles 1009 may also be presented at the application layer 1005. For example, the information management application referred to with respect to FIGS. 1-9 may be implemented at the application layer in a suitable computing system. The application layer 1005 may be considered at least one layer above the operating system layer 1001, although some applications may be considered part of the operating system layer 1001. The dynamic application tiles 1009 may be implemented within any type of application, such as a locally installed and executed application, an application executed within the context of a browser application, or any other type of application.

Dynamic module tiles 1007 may also be implemented at the application layer 1005. The dynamic tiles discussed with respect to FIGS. 1-9 are representative of dynamic module tiles 1007. The dynamic module tiles 1007 may be implemented within any type of application, such as a locally installed and executed application, an application executed within the context of a browser application, or any other type of application.

FIG. 10 illustrates one example scenario in which various types of tiles are implemented in various types of applications at the application layer 1005. In this scenario, information management application 1013 includes dynamic application tiles 1019 and dynamic module tiles 1021. Dynamic application tiles 1019 are those tiles that are linked to and provide updates associated with applications other than information management application 1013, such as productivity application 1015 and miscellaneous application 1017. Dynamic module tiles 1021 are those tiles that are linked to and provide updates associated with modules in information management application 1013.

Productivity application 1015, which is representative of any application other than information management application 1013, includes dynamic module tiles 1023 and dynamic application tiles 1025. Dynamic module tiles 1023 are those tiles that are linked to and provide updates associated with modules in productivity application 1015, unless productivity application 1015 lacks any modules. Dynamic application tiles 1025 are those tiles that are linked to and provide updates associated with applications other than productivity application 1015, such as information management application 1013 and miscellaneous application 1017.

The discussion of FIGS. 1-10 for purposes of clarity may have referred to various elements included in information management applications, such as perspectives, icons, menus, graphics, and modules, well as other elements, without referring to those elements as graphical representations of the same or in some other manner indicative of their technical nature. However, it may be appreciated that such terms and phrases may be used interchangeably and such usage or lack thereof does not limit the scope of the present disclosure. To the contrary, the present disclosure may be considered to encompass a wide variety of well-known techniques for graphically representing the various elements included in the various implementations discussed throughout. Thus, at least a portion of these and other elements illustrated in FIGS. 1-10 may be embodied in graphical representations.

The functional block diagrams, operational scenarios, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable storage media having program instructions stored therein for facilitating enhanced views of an information management application that, when executed by a computing system, direct the computing system to at least:
present a link to a dynamic menu within a perspective of an active module of a plurality of modules in the information management application; and
in response to an indication of interest generated with respect to the link, present the dynamic menu comprising a plurality of dynamic icons, each of the plurality of icons comprising update information associated with a corresponding module of the plurality of modules in the information management application.

2. The one or more computer readable storage media of claim 1 wherein the link comprises a menu graphic that persists in each of a plurality of perspectives of the plurality of modules in the information management application.

3. The one or more computer readable storage media of claim 1 wherein each of the plurality of dynamic icons comprises a live tile and wherein the program instructions further direct the computing system to update the live tile with the update information.

4. The one or more computer readable storage media of claim 1 wherein to present the dynamic menu, the program instructions direct the computing system to replace the perspective of the active module with the dynamic menu.

5. The one or more computer readable storage media of claim 1 wherein the plurality of modules in the information management application comprises an email module, a contacts module, and a calendar module.

6. The one or more computer readable storage media of claim 5 wherein the plurality of dynamic icons comprises an email icon linked to the email module, a contacts icon linked to the contacts module, and a calendar icon linked to the calendar module.

7. The one or more computer readable storage media of claim 6 wherein the dynamic menu further comprises at least one other dynamic icon linked from within the information management application to another application.

8. A method for facilitating enhanced views of an information management application, the method comprising:
presenting a link to a dynamic menu within a perspective of an active module of a plurality of modules in the information management application; and
in response to an indication of interest generated with respect to the link, presenting the dynamic menu comprising a plurality of dynamic icons, each of the plurality of icons comprising update information associated with a corresponding module of the plurality of modules in the information management application.

9. The method of claim 8 wherein the link comprises a menu graphic and wherein the method further comprises persisting the menu graphic in each of a plurality of perspectives of the plurality of modules in the information management application.

10. The method of claim 8 wherein each of the plurality of dynamic icons comprises a live tile and wherein the method further comprises updating the live tile with the update information.

11. The method of claim 8 wherein presenting the dynamic menu comprises replacing the perspective of the active module with the dynamic menu.

12. The method of claim 8 wherein the plurality of modules in the information management application comprises an email module, a contacts module, and a calendar module.

13. The method of claim 12 wherein the plurality of dynamic icons comprises an email icon linked to the email module, a contacts icon linked to the contacts module, and a calendar icon linked to the calendar module.

14. The method of claim 13 wherein the dynamic menu further comprises at least one other dynamic icon linked from within the information management application to another application.

15. A computing apparatus comprising:
a storage system having stored thereon program instructions executable by a processing system to facilitate enhanced views of an application;
the processing system operatively coupled with the storage system and directed by the program instructions to at least:
initiate presentation of a menu graphic within a perspective of an active module of a plurality of modules in the application; and
in response to an indication of interest generated with respect to the menu graphic, initiate presentation of a dynamic menu comprising a plurality of live tiles, each of the plurality of live tiles comprising update information associated with a corresponding module of the plurality of modules.

16. The computing apparatus of claim 15 wherein the processing system is further directed by the program instructions to persist the menu graphic in each of a plurality of perspectives of the plurality of modules in the application.

17. The computing apparatus of claim 15 wherein the processing system is further directed by the program instructions to replace the perspective of the active module with the dynamic menu.

18. The computing apparatus of claim 15 wherein the plurality of modules in the application comprises an email module, a contacts module, and a calendar module.

19. The computing apparatus of claim 18 wherein the plurality of live tiles comprises an email tile linked to the email module, a contacts tile linked to the contacts module, and a calendar tile linked to the calendar module.

20. The computing apparatus of claim 15 wherein the dynamic menu further comprises at least one other live tile linked from within the application to another application.
